(19) United States
(12) Patent Application Publication
(10) Pub. No.: US 2021/0326385 A1
(43) Pub. Date: Oct. 21, 2021

(54) COMPUTERIZED DATA CLASSIFICATION BY STATISTICS AND NEIGHBORS.

(71) Applicant: International Business Machines Corporation, Armonk, NY (US)

(72) Inventors: Oded Sofer, Midreshet Ben Gurion (IL); Ofer Halm Biller, Neve Boker (IL)

(21) Appl. No.: 16/852,484

(22) Filed: Apr. 19, 2020

(51) Int. Cl. G06F 16/906; G06F 16/907; G06F 17/18

(52) U.S. Cl. CPC G06F 16/906; G06F 17/18; G06F 16/907

(57) ABSTRACT

A computer-based system and method for classifying examined data in a computerized database may include: calculating statistics of the examined data; comparing the statistics of the examined data with known statistics of a first data category to provide a statistics score; and determining a probability that the category of the examined data matches the first data category based on the statistics score.

### FIELD OF THE INVENTION

The present invention relates generally to classifying data in a database, and specifically to classifying data in a database by statistics and neighbors.

### BACKGROUND

Sensitive information (also referred to as sensitive data) requires strict security control, limited access and disclosure, and may be subject to legal restrictions. Sensitive information contained in records of an organization may constitute an area of concern because of the risk to the organization should records be mishandled or information inappropriately accessed or disclosed. In addition, data protection laws and regulations such as Health Insurance Portability and Accountability Act (HIPAA), general data protection regulation (GDPR) and others, require users of sensitive data to put in place appropriate technical and organizational measures to implement data protection principles. Examples of sensitive data may include credit card numbers, health record identification numbers (ID) (HIPAA defines that as very sensitive), antenna numbers (may identify the location of the caller), salaries, band levels, employee IDs, etc.

Thus, a method for identifying sensitive data in databases is required.

### SUMMARY

According to embodiments of the invention, a system and method for classifying examined data in a computerized database may include calculating statistics of the examined data; comparing the statistics of the examined data with known statistics of a first data category to provide a statistics score; and determining a probability that the category of the examined data matches the first data category based on the statistics score.

According to embodiments of the invention, the examined data may all be of the same category, and the examined data may all be within the same column in the computerized database.

Embodiments of the invention may include determining that the examined data is of the first category if the score is higher than a threshold.

Embodiments of the invention may include obtaining a true classification of the examined data; and if the true classification of the examined data equals the first data category, then adjusting the known statistics of the first data category based on the statistics of the examined data.

According to embodiments of the invention, the calculated statistics may be selected from: average, median, variance, minimum, maximum, standard deviation and correlation.

Embodiments of the invention may include comparing categories of neighboring data of the examined data with expected categories of neighboring data of the first data category to provide a neighbors score; and determining a probability that the category of the examined data matches the first data category based on the statistics score and the neighbors score.

Embodiments of the invention may include calculating the rate of matches of the examined data to each rule of a plurality of rules, and comparing the resulting rates with known rates of matches of the first data category for each rule of the plurality of rules, to provide a set of rule match scores; and determining a probability that the category of the examined data matches the first data category based on the statistics score and the rule match scores.

Embodiments of the invention may include comparing metadata associated with the examined data with known metadata associated with the of the first data category to provide a metadata score; and determining a probability that the category of the examined data matches the first data category based on the statistics score and the metadata score.

Embodiments of the invention may include comparing values of the examined data with the values in a dictionary associated with the first data category to provide a dictionary score; and determining a probability that the category of the examined data matches the first data category based on the statistics score and the dictionary score.

Embodiments of the invention may include using a trained classifier to classify the examined data, wherein the classifier is trained to detect at least the first data category; and determining a probability that the category of the examined data matches the first data category based on the statistics score and the classification provided by the classifier.

Embodiments of the invention may include obtaining a sample data of the first data category; calculating the known statistics of a first data category by calculating statistics of the sample data.

According to embodiments of the invention, a system and method for classifying examined data in a computerized database may include, for a sample of data: obtaining classification of data in columns in a database to not sensitive data and to categories of sensitive data; for a category of sensitive data: calculating probability of matches of the sensitive data for each rule of a plurality of rules; calculating statistics of the sensitive data;

storing metadata associated with the sensitive data; and storing categories of neighbor fields of the sensitive data; for examined data: calculating probability of matches of the examined data for each rule of the plurality of rules and comparing with the probability of matches of the sensitive data for each rule of the plurality of rules to provide rule match scores; calculating statistics of the examined data and comparing with the statistics of the sensitive data to provide statistics score; comparing metadata associated with the examined data with metadata associated with the sensitive data to provide metadata score; comparing categories of neighbor fields of the examined data with categories of neighbor fields of the sensitive data to provide neighbors score; and rating the potential of the examined data to be sensitive data based on the rule match scores, statistics score, metadata score and neighbors score.

### BRIEF DESCRIPTION OF THE DRAWINGS

The subject matter regarded as the invention is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a flowchart of a method for data classification by statistics, according to embodiments of the invention;

FIG. 2 is a flowchart of a method for data classification by neighbors, according to embodiments of the invention;

FIG. 3 is a flowchart of a method for data classification by data characteristics, according to embodiments of the invention; and

FIG. 4 illustrates an example computing device according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device that manipulates and/or transforms data represented as physical (e.g., electronic) quantities within the computer's registers and/or memories into other data similarly represented as physical quantities within the computer's registers and/or memories or other information transitory or non-transitory or processor-readable storage medium that may store instructions, which when executed by the processor, cause the processor to execute operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items unless otherwise stated. Unless explicitly stated, the method embodiments described herein are not constrained to a particular order or sequence. Additionally, some of the described method embodiments or elements thereof can occur or be performed in a different order from that described, simultaneously, at the same point in time, or concurrently.

A database may include organized data stored in a computerized system. Data items in a database may be arranged at least logically as an array or a table of rows and columns (other types of organization may be used). Typically, a row in a database relates to a single entity and each column in the database stores an attribute associated with the entity. A column, sometimes referred to as subsection, includes data items that pertain to a single data category, also referred to as data type. A data category may include a distinct class to which data items belong. Data categories may include name, address, ID number, employee numbers rank, credit card number, etc. All data within a column or a data category typically has the same format (e.g. alphabetical, numeric, number, date, selection among a set of categories, etc.) and describes the same substantive attribute of the entity corresponding to a specific data item within the data having the same category. Data items may be alphabetical, alphanumeric, numerical, or other standard formats.

In many applications, each column in a database may have or include metadata, or a column header, associated with the data in the column. Metadata may be data identifying a data category or column in a database. Ideally, the metadata may include meaningful data describing characteristics of the data or data category without describing the specific entry for a specific data item. For example, meaningful metadata for a date category may include “date” while the data itself, described by the metadata, may be Feb. 3, 1975.

Some of the data categories may be defined as sensitive data and some may not. For example, credit card numbers may be defined as sensitive data, while a number of television screens owned by a family may not. The definition of data category as sensitive may be internal to an organization or imposed on the organization by data protection laws and regulations.

Sensitive data stored by organizations may be subject to specific processing requirements. However, for many organizations, the first challenge involved with handling sensitive data is the identification of the sensitive data in the company databases. Organizations such as banks, credit card companies, insurance companies, hospitals, universities and many others, may have huge databases, some of which are rather old and designed long time before awareness to sensitive data has started. In many organizations the documentation of the structure of the databases is lacking.

A naïve method for identifying sensitive data in a database, or for identifying the category of data in a database, may include identifying the data category based on the metadata, e.g., the column header, associated with the data. For example, one would expect that the column header of credit card numbers would include the phrase ‘credit card’ or ‘numbers’ or some combination or abbreviation of both. However, in many real-life situations, the metadata is meaningless and inconsistent, e.g., different columns of the same category may have different meaningless names. For example, a column header of credit card numbers may be some combination of letters and numbers such as ‘b-32-133’. In addition, some categories of sensitive data or some categories of data in databases may have unique pattern or may obey to some mathematic rule, which may be used to identify that data category. However, many data categories do not have a unique pattern and do not obey to any mathematic rule.

Therefore, classification of data items to data categories based on metadata and unique patterns may be highly inaccurate and inconclusive, and may result in many false-positive and false-negative classifications, especially for numeric data categories. False-negative classifications are problematic since sensitive data may not be recognized and proper provisions may not be taken. False-positive classifications may cause impractical deployment, since too many fields may need to be monitored, analyzed, audited and tracked in high-resolution. This may require very expensive resources allocation, too many security analysts and an auditor to review the outcome. Thus, improving the accuracy of the classification is very crucial.

Embodiments of the invention may provide an automatic and computerized method for identifying sensitive or other data in a database, in some cases without knowing the “title”, label, or metadata, such as column header, associated with the data. Embodiments of the invention may improve the technology of data protection by increasing the accuracy of data category identification and reducing the number of false-positive and false-negative classifications. According to embodiments of the invention, additional tests may be used to affirm or refute potential sensitive data. For example, embodiments of the invention may classify data in databases based on statistics, neighboring data categories, dictionaries, machine learning (ML), etc., in addition to rule matching and metadata. Embodiments of the invention may provide a dynamic classification process that may learn the characteristics of data categories in a database (e.g., customer specific database) and improve the accuracy of detection.

According to embodiments of the invention, statistics of a numeric data category may be a characteristic of the data category and distinctive from statistics of other data categories. For example, Table 1 presents a part of an employee database including three columns, a name column, an age column and a salary column.

TABLE 1
Sample database:

| A-1 | A-2 | A-3 |
|---|---|---|
| Michael Sax | 33 | 50,000 |
| Jenny Coleman | 45 | 70,000 |
| John Meyer | 60 | 35,000 |
| Deanna Fortune | 24 | 45,000 |
| Brian Akers | 44 | 80,000 |
| Nate Morris | 56 | 90,000 |
| Don Boyle | 34 | 46,000 |
| Jeff Lew | 35 | 46,000 |
| Paul Nixon | 48 | 50,000 |
| Toby Funk | 50 | 100,000 |
| Kim West | 40 | 40,000 |

As can be seen in the sample database presented in Table 1, the column headers are meaningless. Thus, in this example it is not possible to classify the columns to data categories based on the column headers alone. In this example, the first column, having column header A-1 includes data items pertaining to data category “employee name”, the second column, having column header A-2 includes data items pertaining to data category “employee age”, and the third column, having column header A-3 includes data items pertaining to data category “employee salary”. As can be seen in Table 1, the typical values in column A-2 are very different from the typical values in column A-3. It is expected, therefore, that statistics derived from each column be different. Table 2 presents exemplary statistics of columns A-2 and A-3.

TABLE 2
Statistics of column A-2 and column A-3.

| | A-2 | A-3 |
|---|---|---|
| Average | 42.64 | 59272.73 |
| Median | 44 | 50000 |
| Standard | 10.23 | 20967.9 |
| deviation | | |
| Variance | 104.60 | 439652893 |
| Minimum | 24 | 35000 |
| Maximum | 60 | 100000 |

As can be seen in Table 2, the statistics of column A-2 is very different from the statistics of column A-3. According to embodiments of the invention, the statistics of numeric data items in a column may be used to classify the data column. In some embodiments, correlations between data fields may also be calculated and used to classify the data column. For example, in some organization age and salary, rank or band and salary may be correlated.

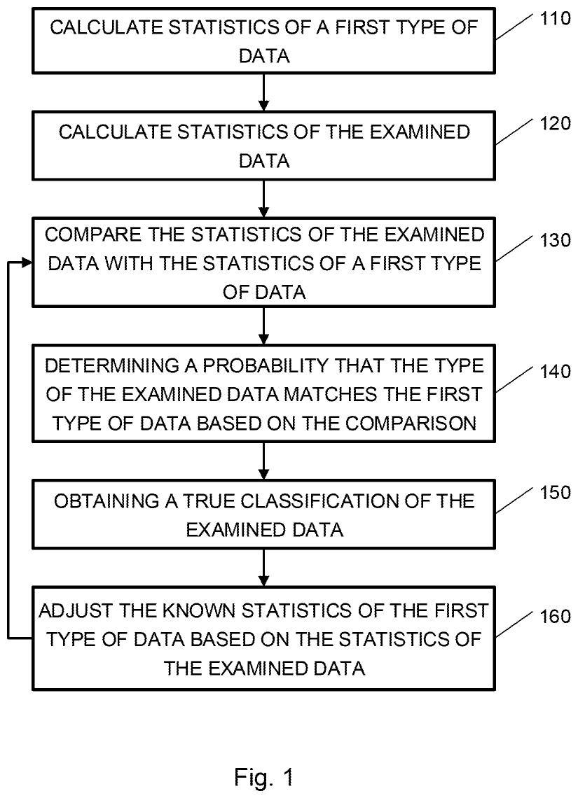

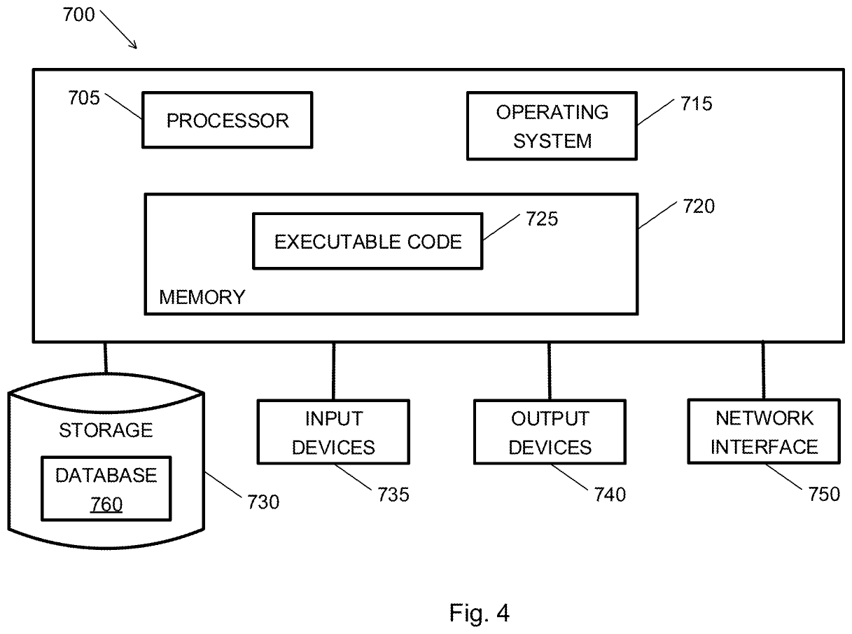

Reference is made to FIG. 1, which is a flowchart of a method for data classification by statistics, according to embodiments of the invention. An embodiment of a method for data classification by statistics may be performed, for example, by the systems shown in FIG. 4. An embodiment of a method for data classification by statistics may be used for classifying numeric data of an unknown category, based on statistics of known data categories. Typically, data examined includes a number of different specific data entries (e.g. a number of different dates or different values) sharing a common data category (e.g. category “date”, or category “salary”). For example, a data category salary, having a not very descriptive column header “B-35”, may have individual data items, of 37,500, 42,000, 100,000, etc.

In operation 110, statistics of a first data category may be calculated or otherwise obtained. For example, statistics of a first data category may be calculated by obtaining a data sample pertaining to the first data category and calculating statistics of the sample data. Typically, the data sample is for a certain section of a database where the data in the section is known or assumed to have a certain category: e.g. a column in a database, where all entries (e.g. all rows) in the column have the same data category, although a different specific data item. In some embodiments, the data sample may include non-customer or organization specific data items. The calculated statistics may include average, median, variance, minimum, maximum, standard deviation, correlation (e.g., with other fields) and other statistics.

In operation 120, statistics of the examined data may be calculated. According to embodiments of the invention, the examined data may all be customer specific or organization specific. According to embodiments of the invention, the examined data may all be of the same category, and the examined data may all be within the same column or subgroup in the computerized database (e.g., database 760 depicted in FIG. 4). Typically, the examined data is taken from a certain section of the examined database where the data in the section is known or assumed to have a certain category: e.g. a column in the database, where all entries (e.g. all rows) in the column has the same data category, although a different specific data item.

In operation 130, the statistics of the examined data may be compared with the known statistics of the first data category (e.g., the statistics obtained or calculated in operation 110). In some embodiments, the comparison may include comparing data items of the examined data against the known statistics of the first data category, e.g., is the data item between the minimum and maximum value of the first data category, how far it is from the average (in terms of standard deviation), etc. In operation 140, a statistics score or a probability that the category of the examined data matches or is the same category as the first data category may be determined or calculated based on the comparison. For example, the statistics score or probability may equal the difference, the ratio, or any other measure of similarity between the statistics of the examined data and the known statistics of a first data category. Additionally or alternatively, the statistic score may be determined based on the ratio between data items with values within the minimum and maximum value of the first data category and the total number of examined values, the average distance of the examined values from the average (in terms of standard deviation), etc. In some embodiments, it may be determined that the examined data is of the first category if the score is higher than a threshold.

In operation 150, a true classification of the examined data may be obtained, for example from a user. For example, a human observer may examine a sample of the classified column and provide the true classification. In operation 160, the known statistics of the first data category may be adjusted based on the statistics of the examined data, if the true classification of the examined data equals the first data category. If the true classification of the examined data does not equal the first data category, e.g., the examined data pertains to a different data category then, in some embodiments the statistics of the other data category may be adjusted based on the statistics of the examined data. Adjusting the statistics of a data category may include replacing the known statistics of the first data category with the statistics of the examined data, or calculating new statistics of a combination of the data previously used for calculating the statistics and the examined data. In some embodiments, an embodiment may repeat for classifying examined data, e.g., another column of the same or other database. In some embodiments, the method may repeat for comparing the examined data to different data categories, e.g., until a classification is found. Operations 150 and 160 are optional and may be used to adjust the statistics of the first data category to the actual statistics of the examined data.

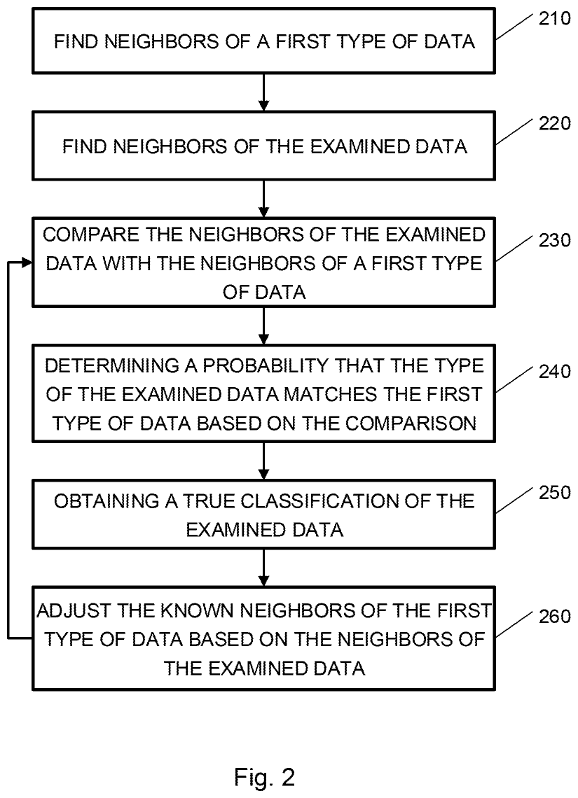

Reference is made to FIG. 2, which is a flowchart of a method for data classification by neighboring data categories, according to embodiments of the invention. An embodiment of a method for data classification by neighboring data categories (also referred to herein as neighbors) may be performed, for example, by the systems shown in FIG. 4. An embodiment of a method for data classification by neighbors may be used for classifying data of an unknown category, based on neighbors of known data categories.

In operation 210, expected neighbors of examined data pertaining to a first category may be found or determined. The expected neighbors may include data pertaining to categories that are expected to be found in proximity to the first data category, e.g., in other columns in the same database, in adjacent columns in a database, or in near columns, e.g., one to three columns apart, in a database, in other columns in the same table, in other columns in linked tables, procedure's signature (input/output), synonym's attributes, view's attributes. For example, if a column of credit card numbers is found in a database, it is expected that the same database would include names of the credit card holders, ID numbers of the credit card holders, bank account numbers, and other related data categories. Thus, if columns of names of the credit card holders, ID numbers of the credit card holders, bank account numbers are found in a database, chances are high that a column of credit card numbers would be found in the same database. In some embodiments, expected neighbors of a first data category may be obtained from a user, e.g., based on common knowledge. In some embodiments, expected neighbors of a first data category may be found or determined by examining a data sample that is known to pertain to the first data category and finding its neighbors. In some embodiments, the data sample may be generic database samples, e.g., non-customer or organization specific.

In operation 220, neighbors of the examined data may be found. According to embodiments of the invention, the examined data may all be customer specific or organization specific. According to embodiments of the invention, the examined data may all be of the same category, and the examined data may all be within the same column or subgroup in the computerized database (e.g., database 760 depicted in FIG. 4). In some embodiments, a weight or an importance factor may be associated with each neighbor category. According to embodiments of the invention, neighbors may be found in case that at least some of the data categories in the database are known. For example, if some of the data categories in the database have meaningful metadata, are classified by statistics or are otherwise known, this information may be used to classify unknown data in the database.

In operation 230, known neighbors of the examined data may be compared with expected neighbors of a first data category. In operation 240, a ‘neighbors’ score or a probability that the category of the examined data matches the first data category may be determined based on the neighbors. In some embodiments the ‘neighbors’ score or probability may be calculated based on the comparison. For example, the neighbors score may equal the number (or a function of the number) of the expected neighbors found in a predetermined proximity to the unknown data, a weighted sum of the expected neighbors found in a predetermined proximity to the unknown data weighted by an importance factor associated with the neighbor category, or any other measure of similarity between the expected neighbors and the examined data. In some embodiments, it may be determined that the examined data is of the first category if the neighbors score is higher than a threshold.

In operation 250, a true classification of the examined data may be obtained, for example from a user. In operation 260, the list of known or expected neighbors of the first data category may be adjusted or updated based on the neighbors of the examined data, if the true classification of the examined data equals the first data category. If the true classification of the examined data does not equal the first data category, e.g., the examined data pertains to a different data category then, in some embodiments, the expected neighbors of the other data category may be adjusted or updated based on the based on the neighbors of the examined data. Adjusting the expected neighbors of a data category may include replacing the expected neighbors of the first data category with the neighbors of the examined data, or adding new neighbors to the expected neighbors. In some embodiments, the method may repeat for classifying examined data, e.g., another column of the same or other database. Some embodiments may repeat for comparing the examined data to different categories of data. Operations 250 and 260 are optional and may be used to adjust the list of expected neighbors to the actual neighbors of the examined data.

According to some embodiment, more than one test may be used in order to classify unknown data in a database. For example, the metadata may be examined, as well as the statistics and neighbors, and/or other tests. In some embodiments, a combined score or a combined probability that the examined data is of a first data category may be calculated based on scores of the plurality of tests. Performing a plurality of test may increase the accuracy of classification of unknown data categories.

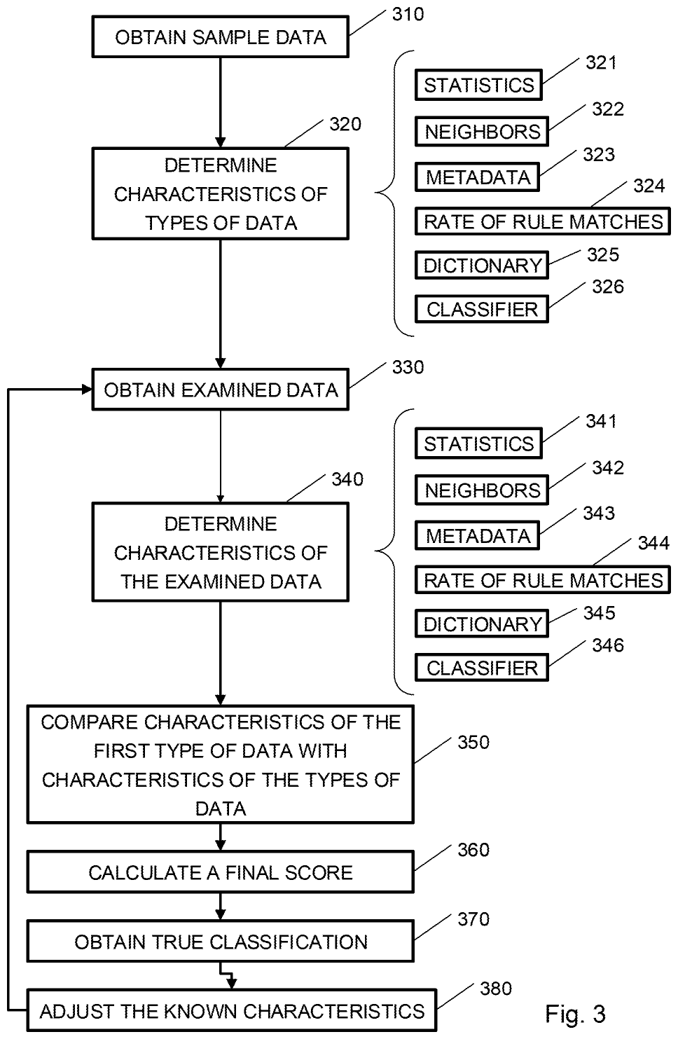

Reference is made to FIG. 3, which is a flowchart of a method for data classification by data characteristics, according to embodiments of the invention. An embodiment of a method for data classification by data characteristics may be performed, for example, by the systems shown in FIG. 4. An embodiment of a method for data classification by data characteristics may be used for classifying data of an unknown category, based on characteristics of known data categories.

In operation 310, sample data may be obtained. The sample data may include data pertaining to one or more data categories and may be obtained with associated classification to relevant data categories. The sample data may be customer or organization specific or non-customer or organization specific.

In operation 320, one or more characteristics of each of the data categories included in the sample data may be determined. The characteristics of each data category may include one or more of statistics (block 321), neighbors (block 322), metadata (block 323), rate of rule matches (block 324), dictionary matches (block 325) and classifier results (block 326).

As indicated by block 321, statistics of each of the numeric data categories included in the data sample may be calculated, similarly to operation 110. As indicated by block 322, neighbors of each of the data categories in the sample data may be found or determined, similarly to operation 210.

As indicated by block 323, metadata of each of the data categories included in the data sample may be examined. Thus, a dictionary of possible metadata, or metadata associated with a specific data category may be generated.

As indicated by block 324, rate of rule matches to each rule of a plurality of rules of sample data pertaining to each data category, may be calculated. The rate of rule matches may equal the ratio of data items that obey the rule to the total of data items tested. Rules may be defined based on an a priori knowledge, or based on the data itself. For example, in some countries or organizations ID numbers may obey certain mathematic rules. Those rules may be included in the plurality of rules. Another rule examples may include a number of digits in a numeric or alphabetical field, the range of values for numeric fields, etc. Thus, each data item of the sample data pertaining to a data category may be tested against each of the rules. The rate of matches to each rule of data items pertaining to a data category may be calculated and stored. Eventually, each data category would be associated with a series of rule math rates, and the rule match rates may be a characteristic of the data category. Specifically, it may be expected that other data that pertains to the same data category would have similar rates of rule matches.

In operation 325, a dictionary of expected data items per data categories may be built or generated. For example, a dictionary of first names may be generated based on data items in a first name column in the sample data. Additionally or alternatively, a dictionary of expected data items per data category may be built based on a priori knowledge.

In operation 326, a classifier may be trained to classify data items into data categories. The classifier may be trained based on the sample data. The classifier may include any applicable category of classifiers, including neural networks, a Bayes classifier, a linear classifier, logistic regression, support vector machine, etc.

In operation 330, examined data may be obtained. The examined data may be data of a database, e.g., a database of an organization. Typically, the examined data may be divided logically to subgroups or columns of data, each pertaining to a single data category. Thus, each column of the examined data needs to be classified into a data category.

In operation 340, one or more characteristics of each column of the examined data may be determined. The characteristics of each column may include one or more of statistics (block 341), neighbors (block 342), metadata (block 343), rate of rule matches (block 344), dictionary matches (block 345) and classifier results (block 346). In some embodiments, the determined characteristics may be determined based on the data category. For example, statistics may be calculated for numeric data categories and not calculated for alphabetical data categories.

As indicated by block 341, statistics of each of the numeric data columns included in the examined data may be calculated, similarly to operation 120. As indicated by block 342, neighbors that are already known of each of the data categories in the examined data may be found or determined, similarly to operation 220.

As indicated by block 343, metadata of each of the data columns included in the examined data may be examined. Thus, metadata associated with each column of the examined data may be extracted.

As indicated by block 344, rate of rule matches to each rule of the plurality of rules (same rules used in operation 324) of columns of the examined data may be calculated. The rate of rule matches may equal the ratio of data items in the examined column that obey the rule to the total number of data items in the column. Eventually, each column of the examined data would be associated with a series of rule math rates.

In operation 345, values of data items in columns of the examined data may be extracted.

In operation 346, the trained classifier may be used to classify each column of the examined data. In some embodiments the classifier may provide a score (referred to herein as a classification score) indicating the probability of the data in a column to pertain to a data category.

In operation 350, characteristics of the data in each column of the examined data (obtained in operation 340) may be compared with characteristics of the plurality of data categories. A score or a measure of similarity may be generated or calculated based on the comparison.

According to some embodiments, the statistics of each numerical column of the examined data may be compared with the known statistics of each of the data categories to provide a statistics score per data category for each column. The comparison of the statistics of an examined column may be compared with the statistics of a specific data category similarly to operation 140.

According to some embodiments, known neighbors of each column of the examined data (e.g., known neighbors may refer to columns that were already classified) may be compared with the expected neighbors of each of the data categories to provide a ‘neighbors’ score per data category for each column. The comparison of the known neighbors of each column of the examined data with the expected neighbors of a specific data category may be performed similarly to operation 240.

According to some embodiments, the metadata of each column of the examined data may be compared with the known metadata of each of the data categories to provide a metadata score per data category for each column.

According to some embodiments, the rate of rule matches of each column of the examined data may be compared with the known rate of rule matches of each of the data categories to provide a set of rule match scores (e.g., a score for rate matches for each rule) per data category for each column.

According to some embodiments, the values of data items of each column of the examined data may be compared with the values in the dictionaries of expected data items per data categories (the dictionaries generated in operation 325), to provide a dictionary score per data category for each column. For example, a dictionary score per data category per column may equal the ratio of data items in the column that are found in a dictionary, and the entire number of data items in the column.

In operation 360, a final score, or a probability that the category of the examined data matches a first category of data may be calculated based on the comparison performed in operation 350. Operation 360 may be performed for a plurality of data categories, providing a plurality of final scores (or probabilities), each for a single data category. For example, a final score, or the probability that the category of the examined data matches the first category of data may be calculated based on one or more of the statistics score, the neighbors score, the rule match scores, the metadata score, the dictionary score, and the classification provided by the classifier. For example, the final score may equal an average or a weighted average of one or more of the statistics score, the neighbors score, the rule match scores, the metadata score, the dictionary score, and the classification provided by the classifier. In some embodiments, logic may be used to determine the final score or probability, for example, if one of the test scores is above a threshold the final score may determined based on this score alone. Other logic or calculations may be used.

In some embodiments, the tests in operations 340 and 350 may be performed iteratively, starting with the simplest test, checking whether the comparison score is above a threshold which gives high probability of detection and continuing to other teats only if the score is not above the threshold. For example, in some embodiments the metadata (operation 343) may be tested first and if detection is conclusive, e.g., a metadata score above a threshold, then no other tests need to be performed.

In operation 370, a true classification of the examined data may be obtained, e.g., from a user. In operation 380, the known characteristics of the true data category may be adjusted based on the characteristics of the classified data. Adjusting the characteristics of a data category may include replacing the known characteristics of the data category with the characteristics of the examined data that was classified as belonging to this data category, or calculating new characteristics of a combination of the data originally used for calculating the characteristics (e.g., the data obtained in operation 310) and the examined data. Some embodiments may repeat for classifying more examined data, e.g., another column of the same or other database.

FIG. 4 illustrates an example computing device according to an embodiment of the invention. For example, a first computing device 700 with a first processor 705 may be used to classify examined data in a computerized database, according to embodiments of the invention.

Computing device 700 may include a processor 705 that may be, for example, a central processing unit processor (CPU), a chip or any suitable computing or computational device, an operating system 715, a memory 720, a storage 730, input devices 735 and output devices 740. Processor 705 may be or include one or more processors, etc., co-located or distributed. Computing device 700 may be for example a workstation or personal computer, or may be at least partially implemented by one or more remote servers (e.g., in the “cloud”).

Operating system 715 may be or may include any code segment designed and/or configured to perform tasks involving coordination, scheduling, arbitration, supervising, controlling or otherwise managing operation of computing device 700, for example. Operating system 715 may be a commercial operating system. Operating system 715 may be or may include any code segment designed and/or configured to provide a virtual machine, e.g., an emulation of a computer system. Memory 720 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 720 may be or may include a plurality of, possibly different memory units.

Executable code 725 may be any executable code, e.g., an application, a program, a process, task or script. Executable code 725 may be executed by processor 705 possibly under control of operating system 715. For example, executable code 725 may be or include software for classifying examined data in a computerized database, according to embodiments of the invention. In some embodiments, more than one computing device 700 may be used. For example, a plurality of computing devices that include components similar to those included in computing device 700 may be connected to a network and used as a system.

Storage 730 may be or may include, for example, a hard disk drive, a floppy disk drive, a Compact Disk (CD) drive, a CD-Recordable (CD-R) drive, a universal serial bus (USB) device or other suitable removable and/or fixed storage unit. Storage 730 may include or may store one or more databases 760, In some embodiments, some of the components shown in FIG. 4 may be omitted. For example, memory 720 may be a non-volatile memory having the storage capacity of storage 730. Accordingly, although shown as a separate component, storage 730 may be embedded or included in memory 720.

Database 760 may include data organized in any applicable manner. Typically, the data in database 760 may be divided logically into columns, where data in a column pertains to a single data category. In many applications, each column in a database may have or include metadata associated with the data in the column. Database 760 may be at least partially implemented by one or more remote storage devices 730 (e.g., in the “cloud”).

Input devices 735 may be or may include a mouse, a keyboard, a touch screen or pad or any suitable input device. It will be recognized that any suitable number of input devices may be operatively connected to computing device 700 as shown by block 735. Output devices 740 may include one or more displays, speakers and/or any other suitable output devices. It will be recognized that any suitable number of output devices may be operatively connected to computing device 700 as shown by block 740. Any applicable input/output (I/O) devices may be connected to computing device 700 as shown by blocks 735 and 740. For example, a wired or wireless network interface card (MC), a modem, printer or facsimile machine, a universal serial bus (USB) device or external hard drive may be included in input devices 735 and/or output devices 740. Network interface 750 may enable device 700 to communicate with one or more other computers or networks. For example, network interface 750 may include a Wi-Fi or Bluetooth device or connection, a connection to an intranet or the internet, an antenna etc.

Embodiments described in this disclosure may include the use of a special purpose or general-purpose computer including various computer hardware or software modules, as discussed in greater detail below.

Embodiments within the scope of this disclosure also include computer-readable media, or non-transitory computer storage medium, for carrying or having computer-executable instructions or data structures stored thereon. The instructions when executed may cause the processor to carry out embodiments of the invention. Such computer-readable media, or computer storage medium, can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computer” may be any computing system as previously defined herein, or any module or combination of modulates running on a computing system.

For the processes and/or methods disclosed, the functions performed in the processes and methods may be implemented in differing order as may be indicated by context. Furthermore, the outlined steps and operations are only provided as examples, and some of the steps and operations may be optional, combined into fewer steps and operations, or expanded into additional steps and operations.

The present disclosure is not to be limited in terms of the particular embodiments described in this application, which are intended as illustrations of various aspects. Many modifications and variations can be made without departing from its scope. Functionally equivalent methods and apparatuses within the scope of the disclosure, in addition to those enumerated, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used in this disclosure is for the purpose of describing particular embodiments only, and is not intended to be limiting.

This disclosure may sometimes illustrate different components contained within, or connected with, different other components. Such depicted architectures are merely exemplary, and many other architectures can be implemented which achieve the same or similar functionality.

Aspects of the present disclosure may be embodied in other forms without departing from its spirit or essential characteristics. The described aspects are to be considered in all respects illustrative and not restrictive. The claimed subject matter is indicated by the appended claims rather than by the foregoing description. All changes which come within the meaning and range of equivalency of the claims are to be embraced within their scope.

1. A method for classifying examined data in a computerized database, the method comprising:
calculating statistics of the examined data;
comparing the statistics of the examined data with known statistics of a first data category to provide a statistics score; and
determining a probability that the category of the examined data matches the first data category based on the statistics score.

2. The method of claim 1, wherein the examined data is all of the same category, and wherein the examined data is all within the same column in the computerized database.

3. The method of claim 1, comprising determining that the examined data is of the first category if the score is higher than a threshold.

4. The method of claim 1, comprising:
obtaining a true classification of the examined data; and
if the true classification of the examined data equals the first data category, then adjusting the known statistics of the first data category based on the statistics of the examined data.

5. The method of claim 1, wherein the calculated statistics are selected from the list consisting of: average, median, variance, minimum, maximum, standard deviation and correlation.

6. The method of claim 1, comprising:
comparing categories of neighboring data of the examined data with expected categories of neighboring data of the first data category to provide a neighbors score; and
determining a probability that the category of the examined data matches the first data category based on the statistics score and the neighbors score.

7. The method of claim 1, comprising:
calculating the rate of matches of the examined data to each rule of a plurality of rules, and comparing the resulting rates with known rates of matches of the first data category for each rule of the plurality of rules, to provide a set of rule match scores; and
determining a probability that the category of the examined data matches the first data category based on the statistics score and the rule match scores.

8. The method of claim 1, comprising:
comparing metadata associated with the examined data with known metadata associated with the of the first data category to provide a metadata score; and
determining a probability that the category of the examined data matches the first data category based on the statistics score and the metadata score.

9. The method of claim 1, comprising:
comparing values of the examined data with the values in a dictionary associated with the first data category to provide a dictionary score; and
determining a probability that the category of the examined data matches the first data category based on the statistics score and the dictionary score.

10. The method of claim 1, comprising:
using a trained classifier to classify the examined data, wherein the classifier is trained to detect at least the first data category; and
determining a probability that the category of the examined data matches the first data category based on the statistics score and the classification provided by the classifier.

11. The method of claim 1, comprising:
obtaining a sample data of the first data category;
calculating the known statistics of a first data category by calculating statistics of the sample data.

12. A method for detecting potentially sensitive data, the method comprising:
for a sample of data:
obtaining classification of data in columns in a database to not sensitive data and to categories of sensitive data;
for a category of sensitive data:
calculating probability of matches of the sensitive data for each rule of a plurality of rules;
calculating statistics of the sensitive data;
storing metadata associated with the sensitive data; and
storing categories of neighbor fields of the sensitive data;
for examined data:
calculating probability of matches of the examined data for each rule of the plurality of rules and comparing with the probability of matches of the sensitive data for each rule of the plurality of rules to provide rule match scores;
calculating statistics of the examined data and comparing with the statistics of the sensitive data to provide statistics score;
comparing metadata associated with the examined data with metadata associated with the sensitive data to provide metadata score;
comparing categories of neighbor fields of the examined data with categories of neighbor fields of the sensitive data to provide neighbors score; and
rating the potential of the examined data to be sensitive data based on the rule match scores, statistics score, metadata score and neighbors score.

13. A system for classifying examined data in a computerized database, the system comprising:
a memory; and
a processor configured to:
calculate statistics of the examined data;
compare the statistics of the examined data with known statistics of a first data category to provide a statistics score; and
determine a probability that the category of the examined data matches the first data category based on the statistics score.

14. The system of claim 13, wherein the examined data is all of the same category, and wherein the examined data is all within the same column in the computerized database.

15. The system of claim 13, wherein the processor is configured to determine that the examined data is of the first category if the score is higher than a threshold.

16. The system of claim 13, wherein the processor is configured to:
obtain a true classification of the examined data; and
if the true classification of the examined data equals the first data category, then adjust the known statistics of the first data category based on the statistics of the examined data.

17. The system of claim 13, wherein the calculated statistics are selected from the list consisting of: average, median, variance, minimum, maximum, standard deviation and correlation.

18. The system of claim 13, comprising:
comparing categories of neighboring data of the examined data with expected categories of neighboring data of the first data category to provide a neighbors score; and
determining a probability that the category of the examined data matches the first data category based on the statistics score and the neighbors score.

19. The system of claim 18, comprising:
calculating the rate of matches of the examined data to each rule of a plurality of rules, and comparing the resulting rates with known rates of matches of the first data category for each rule of the plurality of rules, to provide a set of rule match scores;
comparing metadata associated with the examined data with known metadata associated with the of the first data category to provide a metadata score;
comparing values of the examined data with the values in a dictionary associated with the first data category to provide a dictionary score;
using a trained classifier to classify the examined data, wherein the classifier is trained to detect at least the first data category; and
determining a probability that the category of the examined data matches the first data category based on the statistics score, the neighbors score, the rule match scores, the metadata score, the dictionary score, and the classification provided by the classifier.

20. The system of claim 19, comprising:
obtaining a sample data of the first data category;
calculating the known statistics of a first data category by calculating statistics of the sample data;
finding the expected categories of neighboring data of the first data category by finding the categories of neighboring data of the sample data;
calculating the known probability of matches of the first data category for each rule of the plurality of rules by calculating known probability of matches of the sample data for each rule of the plurality of rules;
finding the known metadata associated with the first data category by detecting metadata associated with the sample data;
building the dictionary based on values of data in the sample data; and
training the classifier using the sample data.
